(19) United States
(12) Patent Application Publication
(10) Pub. No.: US 2010/0079698 A1
(43) Pub. Date: Apr. 1, 2010

(54) DISPLAY DEVICE

(75) Inventors: Shohei MATSUMOTO, Chiba (JP); Eiji Oohira, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/566,773

(22) Filed: Sep. 25, 2009

(30) Foreign Application Priority Data
Sep. 26, 2008 (JP) 2008-247070

(51) Int. Cl. G02F 1/1333

(52) U.S. Cl. 349/58

(57) ABSTRACT

A display device having the hybrid panel structure where a display panel can be adhered to a mold more simply compared to the related art in a state where the display panel is adhered to a front panel is provided. A display device includes a display panel which includes a first substrate and a second substrate, a mold which is arranged on a first substrate side of the display panel, and a front panel which is fixed to a second substrate of the display panel, wherein the front panel is larger than the first substrate in a planar size and has an opaque region on a peripheral portion thereof, a side wall is not formed on a surface of the mold to which a peripheral portion of the first substrate is fixed so that the surface of the mold to which the peripheral portion of the first substrate is fixed is flat.

### CROSS-REFERENCE TO RELATED APPLICATION

The disclosure of Japanese Patent Application No. 2008-247070 filed on Sep. 26, 2008, including the specification, drawings and abstract is incorporated herein by reference in its entirety.

### BACKGROUND OF THE INVENTION

1. Field of the Invention

The present invention relates to a display device, and more particularly to a display device which includes a display panel, a mold frame, and a front panel which is arranged on a surface of the display panel.

2. Description of the Related Art

A TFT (Thin Film Transistor)-type liquid crystal display device (also referred to as liquid crystal display module) having a miniaturized liquid crystal display panel where the number of sub pixels is approximately 240×320×3 in color display is widely used as a display part of portable equipment such as a mobile phone.

FIG. 8 is an exploded perspective view showing the schematic constitution of a conventional liquid crystal display device used in a mobile phone.

As shown in FIG. 8, the conventional liquid crystal display device includes a liquid crystal display panel (LCD), and a backlight (B/L) which radiates light to the liquid crystal display panel (LCD).

The backlight (B/L) includes a light guide plate 6 having an approximately rectangular shape, white light emitting diodes (LED) 8 which are arranged on one side surface (light incident surface) of the light guide plate 6, a reflection sheet 7 which is arranged on a lower surface side (a surface on a side opposite to the liquid crystal display panel (LCD)) of the light guide plate 6, a group of optical sheets 5 which is arranged on an upper surface (liquid-crystal-display-panel-side surface) of the light guide plate 6, and a resin mold frame (hereinafter, simply referred to as a mold) 10. The group of optical sheets 5 is, for example, constituted of a lower diffusion sheet, two lens sheets, and an upper diffusion sheet.

In the conventional liquid crystal display device, the group of optical sheets 5, the light guide plate 6 and the LEDs 8 are arranged in the inside of the mold 10 as in the order shown in FIG. 8, and the reflection sheet 7 is arranged below the mold 10.

The liquid crystal display panel (LCD) includes a first substrate 1, a second substrate 2, liquid crystal (not shown in the drawing) which is sandwiched between the first substrate 1 and the second substrate 2, an upper polarizer 4 which is adhered to an upper surface (display screen) of the second substrate 2, and a lower polarizer 3 which is adhered to a lower surface (backlight-side surface) of the first substrate 1.

Here, on a surface of the mold 10 to which the liquid crystal display panel (LCD) is fixed, side walls 10A are formed. The side walls 10A play a role of cushions for protecting edge portions of the first substrate 1 when an impact generated by falling or the like is applied to the liquid crystal display panel (LCD) in the horizontal direction.

Further, a semiconductor chip (DRV) which constitutes a driver or the like is mounted on the first substrate 1. Although a flexible printed circuit board which supplies control signals or the like to the semiconductor chip (DRV) is mounted on the first substrate 1, the flexible printed circuit board is omitted in FIG. 8.

Recently, with respect to the above-mentioned liquid crystal display device, there has been known a liquid crystal display device having the structure where a front panel is fixed to the upper polarizer 4 of the liquid crystal display panel (LCD) by way of an adhesive material having the substantially same refractive index as the polarizer 4 (hereinafter, referred to as the hybrid panel structure). The hybrid panel structure possesses, compared to the structure where a front panel is arranged on an upper polarizer of a liquid crystal display panel (LCD) with a gap layer sandwiched therebetween, advantageous effects such as (1) the dust-free structure (which can reduce mixing of foreign materials), (2) the reduction of thickness of the liquid crystal display device, (3) favorable outdoor visibility and (4) a high brightness ratio.

Here, as a prior art document relating to the invention, Japanese Patent Laid-Open No. 2007-25484 (patent document 1) is named.

### SUMMARY OF THE INVENTION

In the liquid crystal display device having the hybrid panel structure, the liquid crystal display panel (LCD) is firstly adhered to the front panel and, thereafter, the front panel and the mold are adhered to each other. When the front panel is transparent, the liquid crystal display panel (LCD) can be easily adhered to the mold having side walls in a state where the liquid crystal display panel (LCD) is adhered to the front panel. This is because a target (mold) can be observed with naked eyes through the transparent front panel.

However, when an opaque region formed by printing or the like is present on peripheral portions of four sides of the front panel, there may be case where the mold which constitutes the target cannot be observed. In such a case, the adhesion of the liquid crystal display panel (LCD) to the mold having side walls in a state where the liquid crystal display panel (LCD) is adhered to the front panel becomes a difficult operation because the side walls of the mold hampers the operation.

That is, when the opaque region formed by printing or the like is present on the peripheral portions of four sides of the front panel, unless both the adhesion between the front panel and the liquid crystal display panel (LCD) and the adhesion between the front panel and the mold are realized with high accuracy, the side walls of the mold interfere with the liquid crystal display panel (LCD) so that the adhesion of the liquid crystal display panel (LCD) to the mold having the side walls in a state where the liquid crystal display panel (LCD) is adhered to the front panel becomes difficult. Further, the adhesion with high accuracy also has a drawback that such adhesion requires huge capital investment and bears risks.

The invention has been made to overcome the above-mentioned drawbacks of the related art, and it is an object of the invention to provide, in a display device having the hybrid panel structure, a technique which can adhere a display panel to a mold more simply compared to the related art in a state where the display panel is adhered to a front panel.

The above-mentioned and other objects and novel technical features of the invention will become apparent from the description of this specification and attached drawings.

To simply explain the summary of typical inventions among the inventions disclosed in this specification, they are as follows.

(1) The invention is directed to a display device which includes a display panel which includes a first substrate and a second substrate, a mold which is arranged on a first substrate side of the display panel, and a front panel which is fixed to a second substrate of the display panel, wherein the front panel is larger than the first substrate in a planar size and has an opaque region on a peripheral portion thereof, a peripheral portion of the first substrate is fixed to the mold, a side wall is not formed on a surface of the mold to which a peripheral portion of the first substrate is fixed, and a surface of the mold to which the peripheral portion of the first substrate is fixed is flat.

(2) In the display device having the above-mentioned constitution (1), an upper polarizer is arranged on the second substrate, and the front panel is fixed to a surface of the upper polarizer by an adhesive material.

(3) In the display device having the above-mentioned constitution (2), a peripheral portion of the upper polarizer is covered with the opaque region formed on the peripheral portion of the front panel.

(4) In the display device having the above-mentioned constitution (1), a touch panel is interposed between the front panel and the second substrate.

(5) In the display device having the above-mentioned constitution (4), an upper polarizer is arranged on the second substrate, the touch panel is fixed to the upper polarizer by an adhesive material, and the front panel is fixed to the touch panel by an adhesive material.

(6) In the display device having the above-mentioned constitution (5), a peripheral portion of the upper polarizer is covered with the opaque region formed on the peripheral portion of the front panel.

(7) In the display device having the above-mentioned constitution (5), a peripheral portion of the touch panel is covered with the opaque region formed on the peripheral portion of the front panel.

(8) In the display device having any one of the above-mentioned constitutions (1) to (7), a distance between an edge portion of the first substrate and an edge portion of the mold on at least one side of the first substrate and the mold is not less than 0.3 mm.

(9) In the display device having any one of the above-mentioned constitutions (1) to (7), a distance between an edge portion of the first substrate and an edge portion of the mold on two opposing sides of the first substrate and the mold is not less than a combined total of 0.6 mm.

To briefly explain advantageous effects obtained by the typical inventions among the inventions disclosed in this specification, they are as follows.

According to the invention, in a display device having the hybrid panel structure, it is possible to adhere a display panel to a mold more simply compared to the related art in a state where the display panel is adhered to a front panel.

### BRIEF DESCRIPTION OF THE DRAWING

FIG. 1 is a cross-sectional view showing the schematic structure of a liquid crystal display device having the hybrid panel structure according to an embodiment of the invention;

FIG. 2 is a view for explaining a mold of the liquid crystal display device according to the embodiment of the invention;

FIG. 3 is a view for explaining a front panel of the liquid crystal display device according to the embodiment of the invention;

FIG. 4 is a cross-sectional view showing the schematic structure of a modification of the liquid crystal display device having the hybrid panel structure according to the embodiment of the invention;

FIG. 5 is a view showing the structure of the liquid crystal display device having the hybrid panel structure on which the invention is based;

FIG. 6 is a side view showing a state in which the liquid crystal display device shown in FIG. 5 is mounted on a mobile phone (a side view as viewed in the direction indicated by an arrow A in FIG. 5);

FIG. 7 is a side view showing a state in which the liquid crystal display device shown in FIG. 5 is mounted on a mobile phone (a side view as viewed in the direction indicated by an arrow B in FIG. 5);

FIG. 8 is an exploded perspective view showing the schematic constitution of a conventional liquid crystal display device in a mobile phone;

FIG. 9A and FIG. 9B are views for explaining a size of a mold of a liquid crystal display device in a mobile phone used in general;

FIG. 10A and FIG. 10B are views for explaining a size of a mold of a liquid crystal display device having the hybrid panel structure; and

FIG. 11A and FIG. 11B are views for explaining a size of a mold of the liquid crystal display device having the hybrid panel structure according to the embodiment of the invention.

### DESCRIPTION OF THE PREFERRED EMBODIMENT

Hereinafter, an embodiment of the invention where the invention is applied to a liquid crystal display device is explained in detail in conjunction with drawings.

Here, in all drawings for explaining the embodiment, parts having identical functions are given same symbols and their repeated explanation is omitted.

[Structure of Liquid Crystal Display Device on which the Invention is Based]

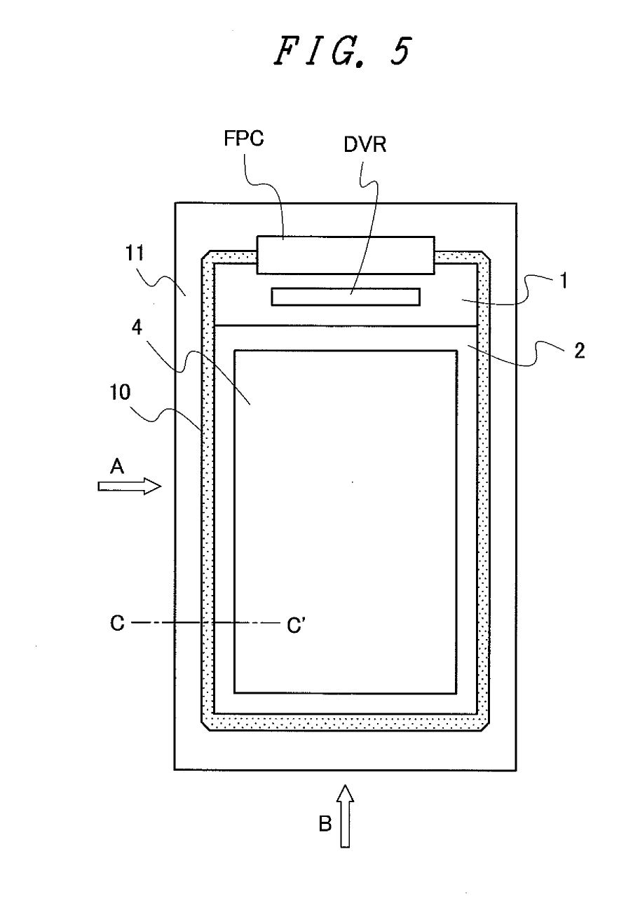

FIG. 5 is a view showing the structure of a liquid crystal display device having the hybrid panel structure on which the invention is based.

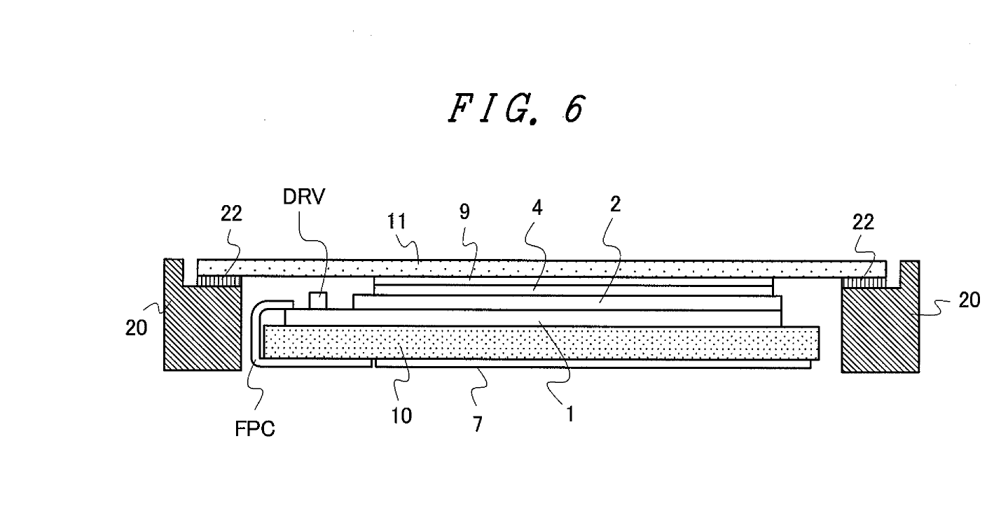

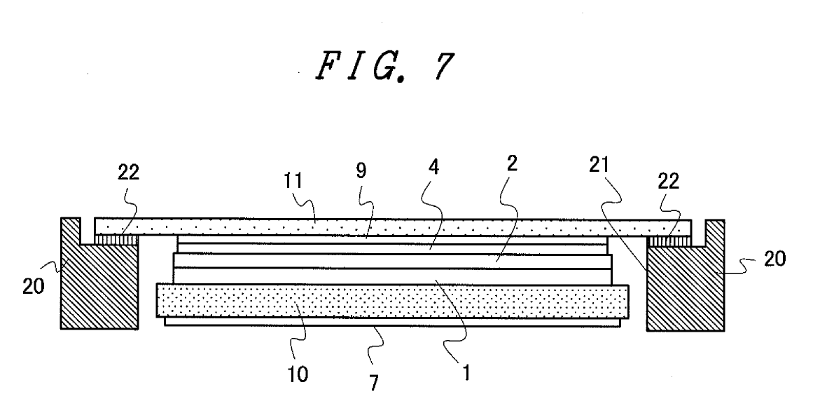

FIG. 6 and FIG. 7 are side views showing a state where the liquid crystal display device shown in FIG. 5 is mounted on a mobile phone, wherein FIG. 6 is a side view as viewed in the direction indicated by an arrow A in FIG. 5, and FIG. 7 is a side view as viewed in the direction indicated by an arrow B in FIG. 5.

The liquid crystal display device having the hybrid panel structure on which the invention is based includes a liquid crystal display panel (LCD), a planar-shaped front panel 11 which is arranged on a viewer-side surface of the liquid crystal display panel (LCD), and a backlight (B/L) which radiates light to the liquid crystal display panel (LCD).

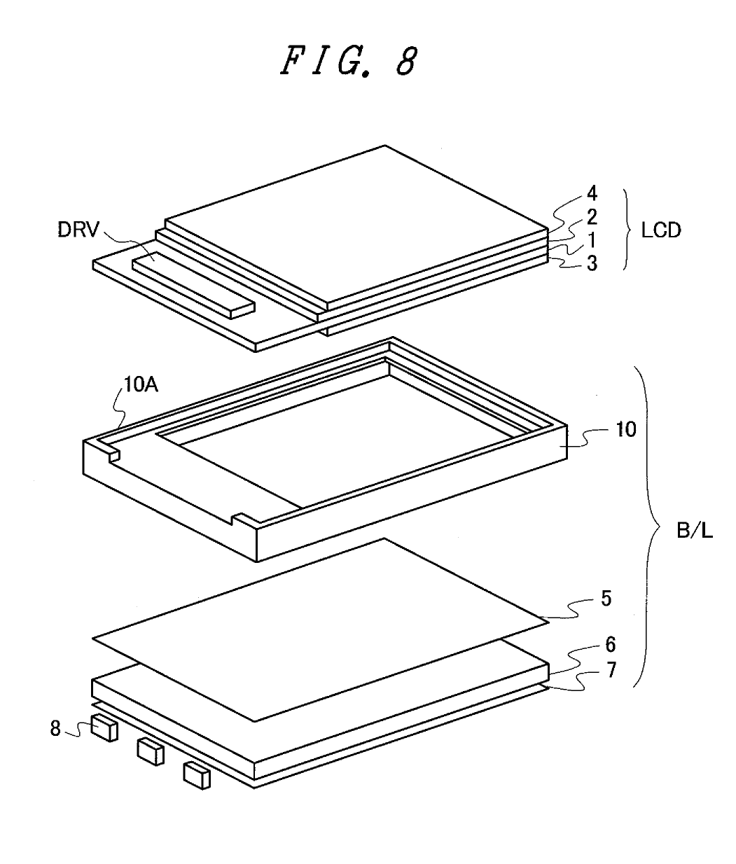

Here, the backlight (B/L) includes, as shown in FIG. 8, a light guide plate having an approximately rectangular shape, white light emitting diodes (LED) which are arranged on one side surface (light incident surface) of the light guide plate, a reflection sheet which is arranged on a lower surface side of the light guide plate, a group of optical sheets which is arranged on an upper surface of the light guide plate, and a resin mold frame (hereinafter, simply referred to as a mold) 10. The group of optical sheets is constituted of a lower diffusion sheet, two lens sheets and an upper diffusion sheet, for example.

The liquid crystal display panel (LCD) includes a first substrate 1, a second substrate 2, a liquid crystal layer (not shown in the drawing) which is sandwiched between the first substrate 1 and the second substrate 2, a semiconductor chip (DRV) on which a drive circuit is mounted, a flexible printed circuit board (FPC) which is connected to at least one side of the first substrate 1, and an upper polarizer 4 which is adhered to the second substrate 2. Here, although not shown in FIG. 5 to FIG. 7, a lower polarizer is adhered to the first substrate 1.

The first and second substrates (1, 2) are formed of a transparent insulating substrate made of glass or the like, for example.

Each of the first and second substrates (1, 2) has a quadrangular planar shape having four corner portions. In this embodiment, for example, each substrate has a rectangular planar shape having long sides and short sides. To compare the first and second substrates (1, 2) to each other, long sides of the first substrate 1 are set longer than long sides of the second substrate 2 so that the first substrate 1 has a region which does not overlap with the second substrate 2 (hereinafter, referred to as a non-overlapping region). The semiconductor chip (DRV) is mounted on the non-overlapping region on a liquid-crystal-layer-side surface of the first substrate 1.

Thin film transistors, pixel electrodes and the like are formed on the first substrate 1, and color filters and the like are formed on the second substrate 2. Here, the liquid crystal display panel (LCD) of this embodiment is an IPS-type liquid crystal display panel and hence, counter electrodes are formed on the first substrate 1 side. However, when the liquid crystal display panel of this embodiment is a TN-type or VA-type liquid crystal display panel, the counter electrodes are formed on the second substrate 2 side. Here, numeral 7 indicates a reflection sheet.

The front panel 11 is fixed to the upper polarizer 4 mounted on the second substrate 2 of the liquid crystal display panel (LCD) by adhesion by way of an adhesive agent 9 having the substantially same refractive index as the upper polarizer 4. The front panel 11 has a quadrangular planar shape having four corner portions.

The planar shape of the front panel 11 is similar to a planar shape of a mold 10 so that a profile line (respective sides) of an outer periphery of the front panel 11 is positioned outside a profile line (respective sides) of an outer periphery of the mold 10. That is, the front panel 11 is larger than the mold 10 in a planar size. The front panel 11 is formed using a transparent insulating material such as glass or a resin (for example, an acrylic resin or the like), for example.

Further, the lower surfaces of portions of four sides of the front panel 11 which are positioned outside four sides of the mold 10 for accommodating and supporting the liquid crystal display panel (LCD), that is, the lower surfaces of portions of four sides of the front panel 11 which project outwardly from the mold 10 are fixed to a casing 20 of portable equipment (for example, a mobile phone) by an adhesive material 22 such as a double-sided adhesive tape or an adhesive agent, for example.

### Embodiment

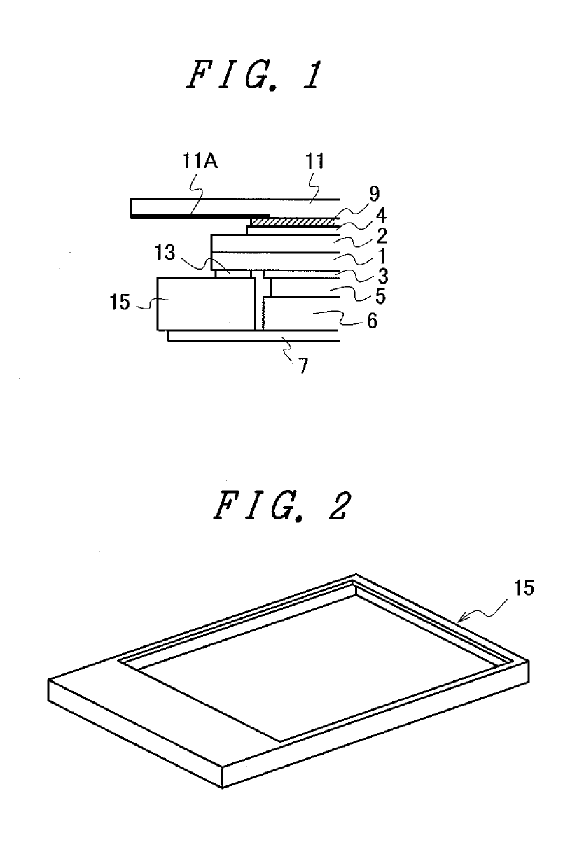

FIG. 1 is a cross-sectional view showing the schematic structure of a liquid crystal display device having the hybrid panel structure according to an embodiment of the invention. Here, FIG. 1 is a cross-sectional view showing the cross-sectional structure taken along a line C-C′ in FIG. 5.

The liquid crystal display device of this embodiment also includes a liquid crystal display panel (LCD) and a backlight (B/L) which radiates light to the liquid crystal display panel (LCD).

As described previously, the backlight (B/L) includes the light guide plate 6, white light emitting diodes (LED) 8, a reflection sheet 7 which is arranged on a lower surface side of the light guide plate 6, a group of optical sheets 5 which is arranged on an upper surface side of the light guide plate 6, and a mold 15. Here, the group of optical sheets 5 is constituted of a lower diffusion sheet, two lens sheets, and an upper diffusion sheet, for example.

The liquid crystal display panel (LCD) includes a first substrate 1, a second substrate 2, a liquid crystal layer (not shown in the drawing) which is sandwiched between the first substrate 1 and the second substrate 2, an upper polarizer 4 which is adhered to an upper surface (display screen) of the second substrate 2, and a lower polarizer 3 which is adhered to a lower surface (backlight-side surface) of the first substrate 1.

Here, in the liquid crystal display panel (LCD), peripheral portions of four sides of the first substrate 1 are fixed to the mold 15 by a double-sided adhesive tape 13 and are arranged on the mold 15.

FIG. 2 is a view for explaining the mold 15 of this embodiment.

As shown in FIG. 2, in this embodiment, side walls 10A are not formed on a surface of the mold 15 to which the liquid crystal display panel (LCD) is fixed so that the surface is flat.

Also in this embodiment, the front panel 11 is fixed to the upper polarizer 4 mounted on the second substrate 2 of the liquid crystal display panel (LCD) by adhesion by way of an adhesive agent 9 having the substantially same refractive index as the upper polarizer 4.

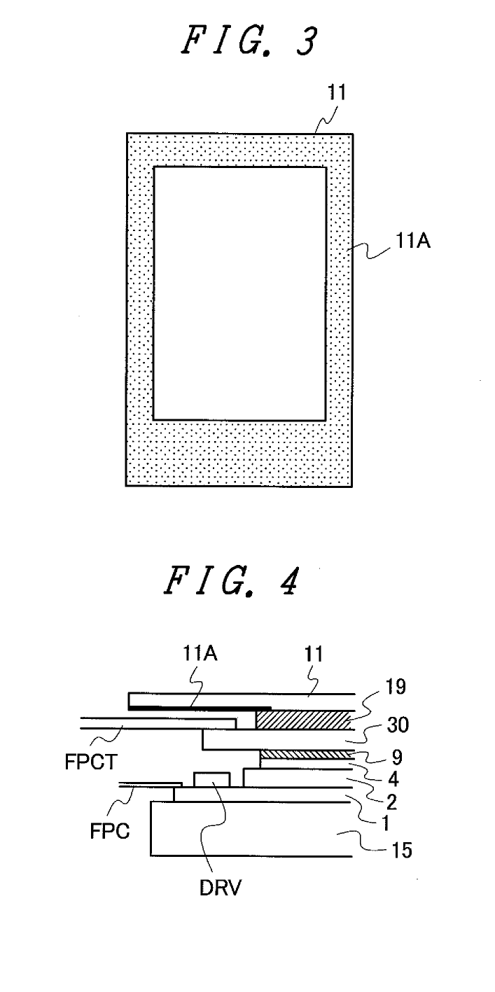

FIG. 3 is a view for explaining the front panel 11 of this embodiment.

As shown in FIG. 3, the front panel 11 of this embodiment is also larger than the mold 10 in a planar size. However, in this embodiment, an opaque region 11A is formed on peripheral portions of four sides of the front panel 11 on a back-surface side (on a side opposite to a viewer-side surface) by printing or the like.

As shown in FIG. 1, the peripheral portions of four sides of the upper polarizer 4 are covered with the opaque region 11A formed on the peripheral portions of four sides of the front panel 11. A transparent region defined within the opaque region 11A formed on the peripheral portions of four sides of the front panel 11 constitutes a display region.

As described above, when the opaque region 11A formed by printing or the like is present on the peripheral portions of four sides of the front panel 11, unless both the adhesion between the front panel 11 and the liquid crystal display panel (LCD) and the adhesion between the front panel 11 and the mold 10 are realized with high accuracy, side walls of the mold interfere with the liquid crystal display panel (LCD) and hence, there exists a drawback that it is difficult to adhere the liquid crystal display panel (LCD) to the mold having the side walls in a state where the liquid crystal display panel (LCD) is adhered to the front panel.

However, in this embodiment, on the surface of the mold 15 to which the liquid crystal display panel (LCD) is fixed, the side walls are not formed. That is, the surface is flat. Accordingly, in this embodiment, when the liquid crystal display panel (LCD) is adhered to the mold 15 in a state where the liquid crystal display panel (LCD) is adhered to the front panel 11, the side walls of the mold do not interfere with the liquid crystal display panel (LCD) and hence, it is possible to impart the tolerance to the accuracy in adhesion between the front panel 11 and the liquid crystal display panel (LCD) and the accuracy in adhesion between the front panel 11 and the mold 10.

Accordingly, in this embodiment, the liquid crystal display panel (LCD) can be easily adhered to the mold 15 in a state where the liquid crystal display panel (LCD) is adhered to the front panel 11 compared to the related art. Eventually, according to this embodiment, in the liquid crystal display device having the hybrid panel structure, it is possible to reduce a size of an external shape of the mold 15.

This technical feature is further explained hereinafter.

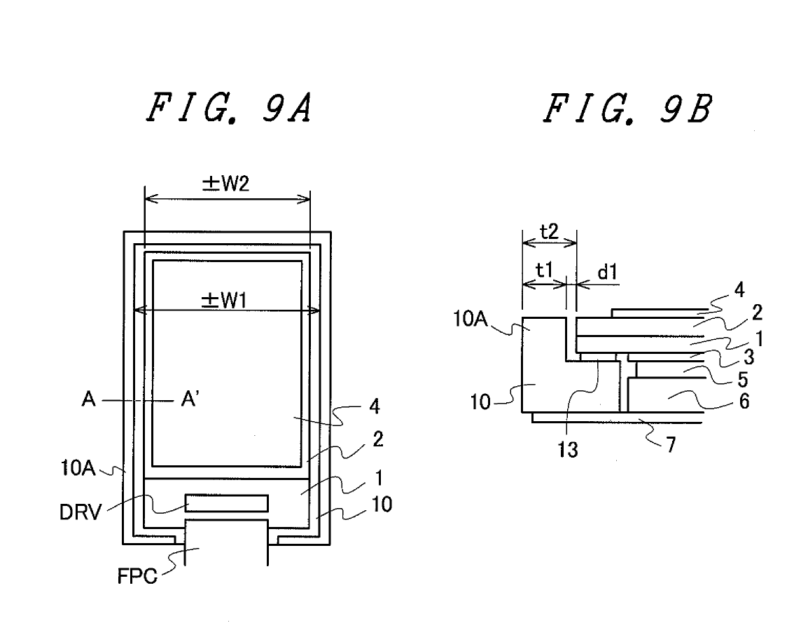

FIG. 9A and FIG. 9B are views for explaining a size of the mold 10 of a liquid crystal display device for a mobile phone used in general, wherein FIG. 9A is a plan view and FIG. 9B is a cross-sectional view showing the cross-sectional structure taken along a line A-A′ in FIG. 9A.

In case of the liquid crystal display device for the mobile phone used in general, assuming the tolerance in size of an inner side (inter-wall side) between the mold walls as ±W1 and assuming the tolerance in size of the liquid crystal display panel (LCD) as ±W2, it is sufficient to ensure the clearance (gap) d1 between an edge portion of the liquid crystal display panel (LCD) and a side wall 10A of the mold 10 by taking the relationship expressed by a following formula (1) into consideration.

[Formula 1]

d1≧(root mean square of W1 and W2)×½ (1)

Here, as expressed by a following formula (2), a size t2 from the edge portion of the liquid crystal display panel (LCD) to an outermost side of the mold 10 becomes a sum of the clearance d1 between the edge portion of the liquid crystal display panel (LCD) and the side wall 10A of the mold 10 and a thickness t1 of the side wall 10A of the mold 10.

[Formula 2]

t2=t1+d1 (2)

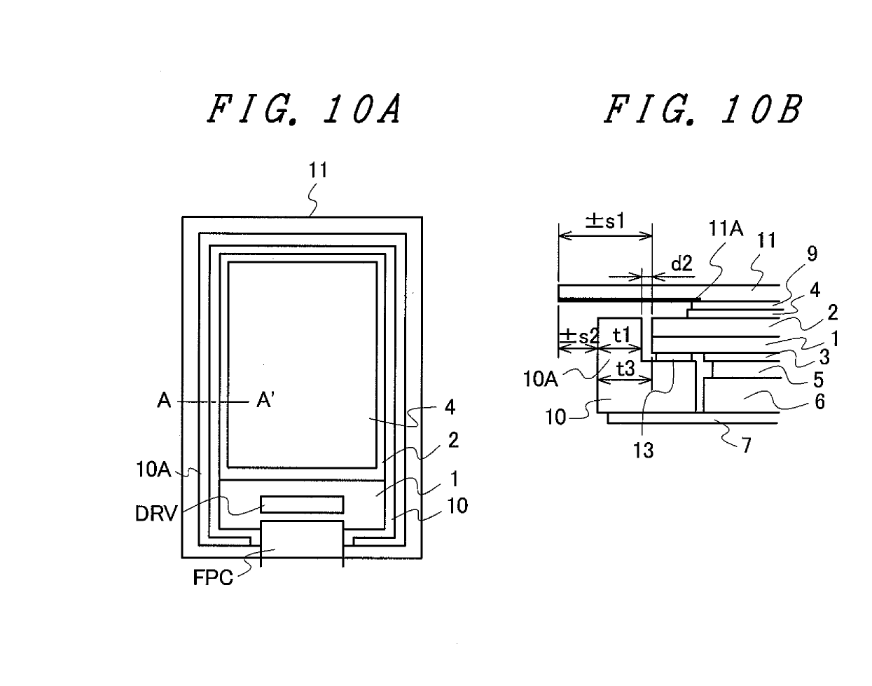

FIG. 10A and FIG. 10B are views for explaining a size of the mold 10 of the liquid crystal display device having the hybrid panel structure, wherein FIG. 10A is a plan view, and FIG. 10B is a cross-sectional view showing the cross-sectional structure taken along a line A-A′ in FIG. 10A.

Assuming the tolerance in adhesion between the front panel 11 and the liquid crystal display panel (LCD) as ±s1 and the tolerance in adhesion between the front panel 11 and the mold 10 as ±s2, it is sufficient to ensure the clearance d2 between the liquid crystal display panel (LCD) and the side wall 10A of the mold 10 by taking the relationship expressed by a following formula (3) into consideration.

[Formula 3]

d2≧root mean square of s1 and s2 (3)

The reason why the edge portions of four sides of the front panel 11 are adopted as the reference of adhesion is that the front panel 11 is basically formed of a panel including an opaque region 11A.

Here, a size t3 from the edge portion of the liquid crystal display panel (LCD) to the outermost side of the mold 10 becomes, as expressed by a following formula (4), a sum of the clearance d2 between the edge portion of the liquid crystal display panel (LCD) and the side wall 10A of the mold 10 and the thickness t1 of the side wall 10A of the mold 10.

[Formula 4]

t3=t1+d2 (4)

The clearance d2 explained in conjunction with FIG. 10 is larger than the clearance d1 explained in conjunction with FIG. 9. This is because [(root mean square of W1 and W2)×½] is smaller than (root mean square of s1 and s2).

As a specific example of numerical values, assuming w1 as 0.1 mm and w2 as 0.2 mm, d1 becomes 0.12 mm. On the other hand, assuming s1 as 0.3 mm and s2 as 0.25 mm, d2 becomes 0.39 mm.

Accordingly, to compare the size t2 from the edge portion of the liquid crystal display panel (LCD) to the outermost side of the mold 10 and the size t3 from the edge portion of the liquid crystal display panel (LCD) to the outermost side of the mold 10 to each other, when the thickness t1 is 0.5 mm, t2 becomes 0.62 mm and t3 becomes 0.89 mm. Accordingly, an external-shape size of the mold 10 of the liquid crystal display device having the hybrid panel structure shown in FIG. 10A and FIG. 10B becomes larger than an external-shape size of the mold of the liquid crystal display device used in general.

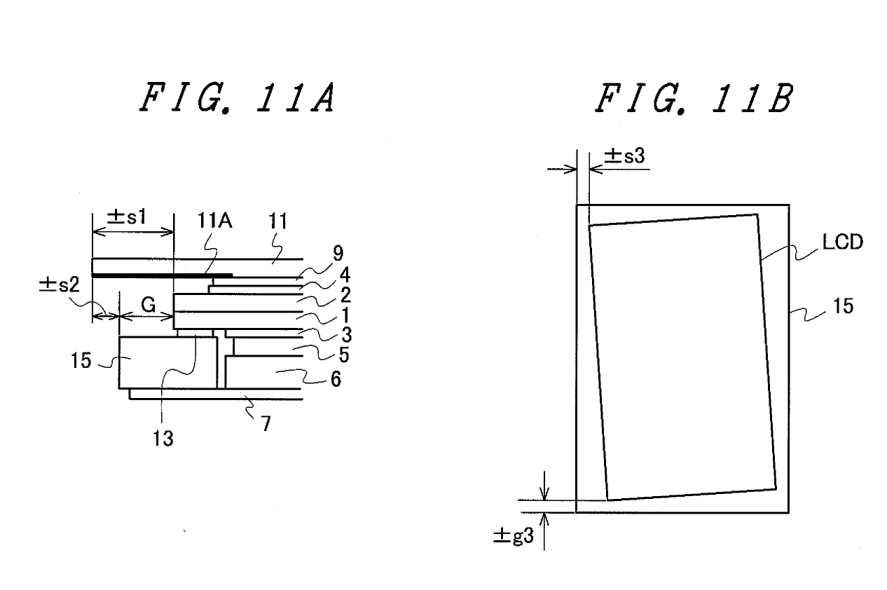

FIG. 11A and FIG. 11B are views for explaining a size of the mold 15 of the liquid crystal display device having the hybrid panel structure of this embodiment.

In the explanation made above, t3=0.89 mm is calculated based on the premise that t1=0.5 mm. When the side walls are eliminated as in the case of the mold 15 of this embodiment, t1 becomes 0. When t1 becomes 0, assuming t2 as 0.62 mm, a distance G from the edge portion of the liquid crystal display panel (LCD) to the edge portion of the mold 10 becomes 0.39 mm.

As described above, in the liquid crystal display device of this embodiment having the hybrid panel structure, the size of the external shape of the mold 15 can be reduced. That is, particularly in the liquid crystal display device having the hybrid panel structure, the elimination of the side walls of the mold is an extremely effective means for reducing the size of the external shape of the mold (or for realizing the size of the external shape of the mold substantially equal to the size of the external shape of the mold of the conventional liquid crystal display device having the non-hybrid panel structure).

Although the side walls of the mold may become an obstacle for the liquid crystal display panel (LCD) with large positional irregularities in the liquid crystal display device having the hybrid panel structure, by removing the side walls of the mold in this manner, it is possible to completely eliminate the possibility that the side walls of the mold becomes an obstacle.

Here, assuming the tolerance in adhesion between the front panel 11 and the liquid crystal display panel (LCD) as ±s1, the tolerance in adhesion between the front panel 11 and the mold 15 as ±s2, and the allowable size tolerance when the liquid crystal display panel (LCD) is rotated relative to the mold 15 as ±s3, it is sufficient to ensure a distance G from the edge portion of the liquid crystal display panel (LCD) to the edge portion of the mold 10 by taking the relationship expressed by a following formula (5) into consideration.

[Formula 5]

G≧root mean square of s1, s2 and s3 (5)

As a specific example of numerical values, when s1 is 0.2 mm, s2 is 0.2 mm, and s3 is 0.1 mm, the distance G becomes 0.3 mm.

Accordingly, in this embodiment, the distance G from the edge portion of the liquid crystal display panel (LCD) to the edge portion of the mold 10 is preferably set to not less than 0.3 mm (not less than a combined total of 0.6 mm on two opposing sides). Here, it is apparent that a maximum value of the distance G is a size from the edge portion of the liquid crystal display panel (LCD) to the casing 20 shown in FIG. 6 and FIG. 7.

### [Modification]

FIG. 4 is a cross-sectional view showing the schematic structure of a modification of the liquid crystal display device having the hybrid panel structure according to the embodiment of the invention. FIG. 4 is also a cross-sectional view showing the cross-sectional structure taken along a line C-C′ in FIG. 5.

The liquid crystal display device shown in FIG. 4 differs from the liquid crystal display device shown in FIG. 1 with respect to a point that a touch panel 30 is arranged between the front panel 11 and the upper polarizer 4. Hereinafter, the liquid crystal display device shown in FIG. 4 is explained by focusing on the difference between the liquid crystal display device shown in FIG. 4 and the liquid crystal display device shown in FIG. 1.

In the liquid crystal display device shown in FIG. 4, the touch panel 30 is fixed to the upper polarizer 4 which is mounted on the second substrate 2 of the liquid crystal display panel (LCD) by adhesion by way of an adhesive agent 9 having the substantially same refractive index as the upper polarizer 4.

Further, the front panel 11 is fixed to the touch panel 30 by adhesion by way of an adhesive agent 19 having the substantially same refractive index as the polarizer 4. Here, symbol FPCT indicates a touch-panel-30—use flexible printed circuit board.

Also in the liquid crystal display device shown in FIG. 4, side walls are not formed on a surface of the mold 15 to which the liquid crystal display panel (LCD) is fixed so that the surface is flat. Further, the distance G from an edge portion of the liquid crystal display panel (LCD) to an edge portion of the mold 10 is not less than 0.3 mm (not less than a combined total of 0.6 mm on two opposing sides).

Here, the explanation has been made with respect to the constitution of the long side of the front panel 11 (or the mold 15) in the above-mentioned respective embodiments. However, also with respect to the constitution of the short side of the front panel 11 (or mold 15), in the same manner as the constitution of the long side of the front panel 11 (or the mold 15), the distance G from the edge portion of the liquid crystal display panel (LCD) to the edge portion of the mold 10 is preferably set to not less than 0.3 mm (not less than a combined total of 0.6 mm on two opposing sides).

Further, in the above-mentioned embodiments, an example in which the invention is applied to the liquid crystal display device has been explained. However, the invention is not limited to the above-mentioned embodiments, and the invention is applicable to a display module including other display panel such as an organic EL display panel or an inorganic EL display panel.

Although the inventions made by inventors of the invention have been specifically explained in conjunction with the above-mentioned embodiments, it is needless to say that the invention is not limited to the above-mentioned embodiments and various modifications are conceivable without departing from the gist of the invention.

What is claimed is:

1. A display device comprising:
a display panel which includes a first substrate and a second substrate;
a mold which is arranged on a first substrate side of the display panel; and
a front panel which is fixed to a second substrate of the display panel; wherein
the front panel is larger than the first substrate in a planar size and has an opaque region on a peripheral portion thereof,
a peripheral portion of the first substrate is fixed to the mold, and
a surface of the mold to which the peripheral portion of the first substrate is fixed is flat.

2. A display device according to claim 1, wherein an upper polarizer is arranged on the second substrate, and the front panel is fixed to a surface of the upper polarizer by an adhesive material.

3. A display device according to claim 2, wherein a peripheral portion of the upper polarizer is covered with the opaque region formed on the peripheral portion of the front panel.

4. A display device according to claim 1, wherein a touch panel is interposed between the front panel and the second substrate.

5. A display device according to claim 4, wherein an upper polarizer is arranged on the second substrate, the touch panel is fixed to the upper polarizer by an adhesive material, and the front panel is fixed to the touch panel by an adhesive material.

6. A display device according to claim 5, wherein a peripheral portion of the upper polarizer is covered with the opaque region formed on the peripheral portion of the front panel.

7. A display device according to claim 6, wherein a peripheral portion of the touch panel is covered with the opaque region formed on the peripheral portion of the front panel.

8. A display device according to claim 1, wherein a distance between an edge portion of the first substrate and an edge portion of the mold on at least one side of the first substrate and the mold is not less than 0.3 mm.

9. A display device according to claim 1, wherein a distance between an edge portion of the first substrate and an edge portion of the mold on two opposing sides of the first substrate and the mold is not less than a combined total of 0.6 mm.

10. A display device comprising:
a display panel which includes a first substrate and a second substrate;
a mold which is arranged on a first substrate side of the display panel; and
a front panel which is fixed to a second substrate of the display panel; wherein
the front panel is larger than the first substrate in a planar size and has an opaque region on a peripheral portion thereof,
a peripheral portion of the first substrate is fixed to the mold, and
a side wall is not formed on a surface of the mold to which the peripheral portion of the first substrate is fixed.

11. A display device according to claim 10, wherein an upper polarizer is arranged on the second substrate, and the front panel is fixed to a surface of the upper polarizer by an adhesive material.

12. A display device according to claim 11, wherein a peripheral portion of the upper polarizer is covered with the opaque region formed on the peripheral portion of the front panel.

13. A display device according to claim 10, wherein a touch panel is interposed between the front panel and the second substrate.

14. A display device according to claim 13, wherein an upper polarizer is arranged on the second substrate, the touch panel is fixed to the upper polarizer by an adhesive material, and the front panel is fixed to the touch panel by an adhesive material.

15. A display device according to claim 14, wherein a peripheral portion of the upper polarizer is covered with the opaque region formed on the peripheral portion of the front panel.

16. A display device according to claim 15, wherein a peripheral portion of the touch panel is covered with the opaque region formed on the peripheral portion of the front panel.

17. A display device according to claim 10, wherein a distance between an edge portion of the first substrate and an edge portion of the mold on at least one side of the first substrate and the mold is not less than 0.3 mm.

18. A display device according to claim 10, wherein a distance between an edge portion of the first substrate and an edge portion of the mold on two sides of the first substrate and the mold opposite to each other is not less than 0.6 mm in total.
